(19) United States
(12) Patent Application Publication
(10) Pub. No.: US 2010/0223231 A1
(43) Pub. Date: Sep. 2, 2010

(54) Merging Records From Different Databases

(75) Inventor: Kenneth H. Lee, Rancho Palos Verdes, CA (US)

Correspondence Address: BAKER BOTTS LLP, 2001 ROSS AVENUE, 6TH FLOOR, DALLAS, TX, 75201-2980, US

(73) Assignee: Thales-Raytheon Systems Company LLC, Fullerton, CA (US)

(21) Appl. No.: 12/711,430

(22) Filed: Feb. 24, 2010

Related U.S. Application Data
(60) Provisional application No. 61/156,762, filed on Mar. 2, 2009.

(51) Int. Cl. G06F 17/30; G06N 5/02

(52) U.S. Cl. 707/610; 707/641; 707/E17.041; 706/47

(57) ABSTRACT

According to certain embodiments, merging records includes receiving a graph comprising nodes, each node representing a record of a first database. The following is performed for each record: associate a merge handler of a plurality of merge handlers to a record, each merge handler operable to apply merge rules to the record; identify one or more merge rules to apply to the record; and apply the identified merge rules to the record to merge the record in a second database.

### RELATED APPLICATION

This application claims benefit under 35 U.S.C. §119(e) of U.S. Provisional Application Ser. No. 61/156,762, entitled “Distributed Database Synchronization System,” Attorney's Docket 075719.0109, filed Mar. 2, 2009, by Kenneth H. Lee, which is incorporated herein by reference.

### TECHNICAL FIELD

This invention relates generally to the field of database systems and more specifically to merging records from different databases.

### BACKGROUND

Databases may be structured according to one or more data models. A relational data model groups data using common attributes of the database records. Relational databases abstract common data, which may provide relatively efficient use of physical storage capacity and enhance search performance. Relational databases configured in a multi-site distributed network, however, may be relatively cumbersome to manage due to the distributed data organization.

### SUMMARY OF THE DISCLOSURE

In accordance with the present invention, disadvantages and problems associated with previous techniques for merging records may be reduced or eliminated.

According to certain embodiments, merging records includes receiving a graph comprising nodes, each node representing a record of a first database. The following is performed for each record: associate a merge handler of a plurality of merge handlers to a record, each merge handler operable to apply merge rules to the record; identify one or more merge rules to apply to the record; and apply the identified merge rules to the record to merge the record in a second database.

Certain embodiments of the invention may provide one or more technical advantages. A technical advantage of one embodiment may be that the merge handlers may centralize logic that can apply a set of merge rules. One or more rules of the set may be defined to apply to a particular record, subject to the location of the record within a graph. Another technical advantage of one embodiment may be that the merge rules may reduce or eliminate unnecessary code to merge the graph, which may increase the efficiency of the merge logic.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an embodiment of a system that can merge records from different databases;

FIG. 2 illustrates an example of merging records from different databases; and

FIG. 3 illustrates another example of merging records from different databases.

### DETAILED DESCRIPTION OF THE DRAWINGS

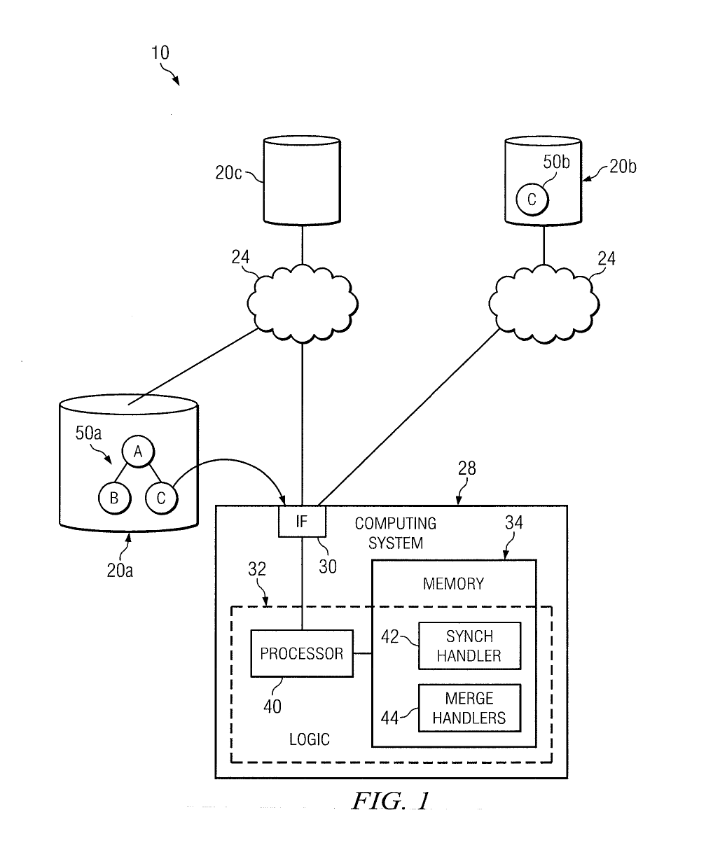

Embodiments of the present invention and its advantages are best understood by referring to FIGS. 1 through 3 of the drawings, like numerals being used for like and corresponding parts of the various drawings.

FIG. 1 illustrates an embodiment of a system 10 that can merge records from different databases. In the embodiment, system 10 includes a plurality of databases 20 (20a-c), one or more networks 24 (24a-b), and a computing system 28 coupled as shown. Computing system 28 includes an interface (IF) 30, logic 32, and a memory 34. Database 20(a-b) stores records represented by graph 50(a-b), respectively. Logic 32 includes a processor 40 and applications such as a synchronization handler 42 and one or more merge handlers 44. Memory 34 stores synchronization handler 42 and merge handlers 44.

In certain embodiments, synchronization handler 42 receives a graph 50a comprising a plurality of nodes, each node representing a record from a first database 20a to be merged at a second database 20b. In the illustrated example, graph 50a includes nodes A, B, and C representing incoming records A, B, and C, respectively. Instead of just creating records in second database 20b from the incoming records, synchronization handler 42 identifies specific merge rules that address specific situations. For example, record C need not be created in second database 20b because record C already exists in second database 20b (as shown by graph 50c).

In the embodiments, synchronization handler 42 performs the following for each record represented by the nodes: associate a merge handler 44 each record, each merge handler operable to apply merge rules to the record; identify one or more merge rules to apply to the record; and apply the identified merge rules to the record to store the record in a second database 20b.

Database 20 may be any suitable database comprising memory operable to store data. In certain embodiments, databases 20 that communicate with each another through a network 24 may form a distributed database. A graph 50(a-b) includes nodes that represent records stored at database 20(a-b), respectively. Edges among the nodes represent the relationships among the records. An example of a graph 50 is a data transfer object (DTO) graph.

In certain embodiments, graph 50 may have a hierarchical structure with nodes that include parent, child, and/or root nodes. A child node may have one or more attributes that define the identity of the child node. Examples of attributes include an individual's contact information, a business's inventory amounts, an airplane's tracking data, and/or other description of a node. A root node may be a parent node that is not a child of any other node. In the example, graph 50a has a root and parent node A with child nodes B and C.

A node representing a record may include any suitable information. For example, the node may include the data of the record that may used to create a new record in second database 20b. As another example, the node may include information for retrieving an existing record in second database 20b. Information for retrieving the record may include, for example, a record identifier and/or location. For example, the node may include a natural key that is used to look up the record in second database 20b.

As yet another example, the node may include instructions indicating one or more merge rules that are to be applied in merge handlers 44. In the example, a parent node may include instructions for merge handlers 44 of one or more child nodes of the parent node, the parent node, or other suitable node.

Network 24 represents a communication network that allows components such as mobile node 20 to communicate with other components. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

In certain embodiments, synchronization handler 42 receives a graph comprising a plurality of nodes, each node representing a record from a first database 20. Graph 50a may be received in an application layer message. In certain embodiments, synchronization handler 42 associates a merge handler 44 for each record. For example, synchronization handler 42 may handle distributing customer data. The records may be of any suitable record type. For example, record A may represent a customer record, record B may represent passport information, and record C may represent the native country of the customer. Synchronization handler may then associate a merge handler 44 of a merge handler class that corresponds to the particular record types. For example, there may be a customer merge handler, passport merge handler, and country merge handler that correspond to records A, B, and C, respectively.

In certain embodiments, synchronization handler 42 identifies one or more merge rules to apply from the parent's record. The merge rules may be identified in any suitable manner. The merge handler of the parent record may define one or more merge rules to apply to one or more children records through the merge handlers associated with the children records. In certain embodiments, the application of the merge rules, or merging, may result in creation, updating or deletion of records in second database 20b.

A merge handler 44 includes logic to apply a set of merge rules to a corresponding record. In certain embodiments, merge handler 44 comprises an executable object, such as executable instructions organized according to object oriented programming principles, for example, using the Java programming language. Merge handlers 44 may be instantiated from class structures that define characteristics of their executable objects.

A set of merge rules that a merge handler 44 can apply may include one or more of any suitable merge rules. Examples of merge rules include:
1. Create a new record in second database 20b using data found in a node from first database 20a.
2. Use an existing record stored in second database 20b instead of creating a new record; and
retain one or more existing attributes of the existing record.
3. Use an existing record stored in second database 20b instead of creating a new record; and
replace one or more existing attributes of the existing record with one or more incoming attributes.
4. Use an existing record stored in second database 20b instead of creating a new record; and
use an existing child record of the existing record, the existing child record stored in second database 20b.
5. Use an existing record stored in the second database 20b instead of creating a new record; and
create a new child record of the existing record, the new child record created from data in a node received from first database 20a.
6. Use an existing record stored in second database 20b instead of creating a new record; and
if a child record in second database 20b does not correspond to a child record from the first database 20a, remove the child record from the second database 20b.
7. If an existing record stored in second database 20b is to be used instead of creating a new record, but there is no existing record, determine that second database 20b need not have the existing record.
8. If an existing record stored in the second database 20b is to be used instead of creating a new record, but there is no existing record, create a new record from data in a node from first database 20a.

If a merge rule includes a condition (“if . . . ”) and a response (“then . . . ”), merge handler 44 may query conditions on databases 20b to determine the condition.

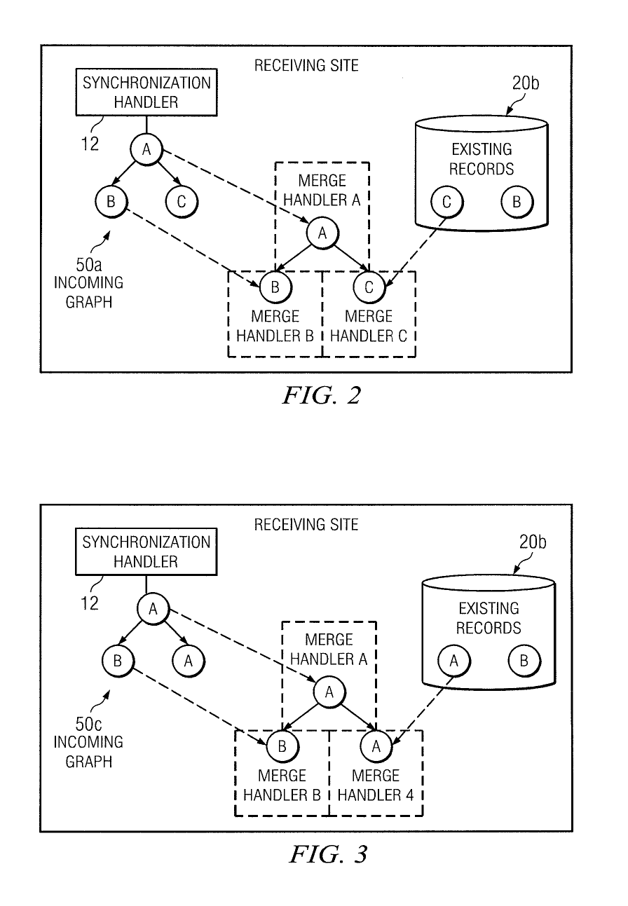

FIG. 2 illustrates an example of merging records from different databases 20. In this particular illustration, graph 50a includes nodes A, B, and C representing incoming records A, B, and C from database 20a. Database 20b has existing records B and C. Synchronization handler 12 uses a merge handler A to handle node A, a merge handler B to handle node B, and a merge handler C to handle node C.

In the example, synchronization handler 12 instructs merge handler A to apply a merge rule that states that a new record should be created in database 20b from the data in node A. Merge handler A also instructs merge handler B to apply a merge rule that states that a new record should be created in database 20b from the data in node B. Record B already exists in database 20b, so there are two record Bs after the update. The existing record B has no relation to the new record B.

Merge handler A also instructs merge handler C to apply a merge rule that states that an existing record should be retrieved from database 20b using retrieval information in node C. This may allow new record A to have a relationship with the existing record C. Once the merge handlers 44 have created a merge hierarchal structure, the entire hierarchal structure may be persisted to database 20b.

FIG. 3 illustrates another example of merging records from different databases 20. In this particular illustration, graph 50c includes nodes A, B, and A representing incoming records A, B, and A from database 20a. Database 20b has existing records A and B.

Different records of type A are represented in the graph, one as a parent and the other as a child. Synchronization handler 12 specifies that the parent merge handler A creates a parent record A from data in the parent node A, and retrieves existing record A from database 20b as child record A.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. For example, the operations of synchronization handler 42 may be performed by more than one component. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

A component of the systems and apparatuses disclosed herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more non-transitory, tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
receiving a graph comprising a plurality of nodes, each node representing a record of a first database; and
performing the following for each record represented by the nodes:
associating a merge handler of a plurality of merge handlers to the each record, each merge handler operable to apply a plurality of merge rules to the each record;
identifying one or more merge rules of the plurality of merge rules to apply to the each record; and
applying the identified one or more merge rules to the each record to merge the each record in a second database.

2. The method of claim 1, the associating the merge handler further comprising:
identifying a record type of a record; and
associating a merge handler of a merge handler class corresponding to the record type to the record.

3. The method of claim 1, the identifying one or more merge rules further comprising:
determining a parent node of a child node; and
identifying the one or more merge rules defined by the parent node to apply to a record represented by the child record.

4. The method of claim 1, the applying the identified one or more merge rules further comprising:
creating a new record in the second database using data from the first database.

5. The method of claim 1, the applying the identified one or more merge rules further comprising:
using an existing record stored in the second database instead of creating a new record.

6. The method of claim 1, the applying the identified one or more merge rules further comprising:
using an existing record stored in the second database; and
retaining one or more existing attributes of the existing record.

7. The method of claim 1, the applying the identified one or more merge rules further comprising:
using an existing record stored in the second database; and
replacing one or more existing attributes of the existing record with one or more incoming attributes from the first database.

8. The method of claim 1, the applying the identified one or more merge rules further comprising:
using an existing record stored in the second database; and
using an existing child record of the existing record, the existing child record stored in the second database.

9. The method of claim 1, the applying the identified one or more merge rules further comprising:
using an existing record stored in the second database; and
creating a new child record of the existing record, the new child record created from data received from the first database.

10. The method of claim 1:
the identifying one or more merge rules further comprising:
identifying a merge rule specifying that an existing record stored in the second database is to be used; and
the applying the identified one or more merge rules further comprising:
determining that there is no existing record; and
determining that the second database need not have the existing record.

11. The method of claim 1:
the identifying one or more merge rules further comprising:
identifying a merge rule specifying that an existing record stored in the second database is to be used; and
the applying the identified one or more merge rules further comprising:
determining that there is no existing record; and
creating a new record data from the first database.

12. One or more non-transitory computer readable media encoding logic when executed by a processor configured to:
receive a graph comprising a plurality of nodes, each node representing a record of a first database; and
perform the following for each record represented by the nodes:
associate a merge handler of a plurality of merge handlers to the each record, each merge handler operable to apply a plurality of merge rules to the each record;
identify one or more merge rules of the plurality of merge rules to apply to the each record; and
apply the identified one or more merge rules to the each record to merge the each record in a second database.

13. The non-transitory computer readable media of claim 12, the associating the merge handler further comprising:
identifying a record type of a record; and
associating a merge handler of a merge handler class corresponding to the record type to the record.

14. The non-transitory computer readable media of claim 12, the identifying one or more merge rules further comprising:
determining a parent node of a child node; and
identifying the one or more merge rules defined by the parent node to apply to a record represented by the child record.

15. The non-transitory computer readable media of claim 12, the applying the identified one or more merge rules further comprising:
creating a new record in the second database using data from the first database.

16. The non-transitory computer readable media of claim 12, the applying the identified one or more merge rules further comprising:
using an existing record stored in the second database instead of creating a new record.

17. The non-transitory computer readable media of claim 12, the applying the identified one or more merge rules further comprising:
using an existing record stored in the second database; and
retaining one or more existing attributes of the existing record.

18. The non-transitory computer readable media of claim 12, the applying the identified one or more merge rules further comprising:
using an existing record stored in the second database; and
replacing one or more existing attributes of the existing record with one or more incoming attributes from the first database.

19. The non-transitory computer readable media of claim 12, the applying the identified one or more merge rules further comprising:
using an existing record stored in the second database; and
using an existing child record of the existing record, the existing child record stored in the second database.

20. The non-transitory computer readable media of claim 12, the applying the identified one or more merge rules further comprising:
using an existing record stored in the second database; and
creating a new child record of the existing record, the new child record created from data received from the first database.

21. The non-transitory computer readable media of claim 12:
the identifying one or more merge rules further comprising:
identifying a merge rule specifying that an existing record stored in the second database is to be used; and
the applying the identified one or more merge rules further comprising:
determining that there is no existing record; and
determining that the second database need not have the existing record.

22. The non-transitory computer readable media of claim 12:
the identifying one or more merge rules further comprising:
identifying a merge rule specifying that an existing record stored in the second database is to be used; and
the applying the identified one or more merge rules further comprising:
determining that there is no existing record; and
creating a new record data from the first database.
